(19) United States
(12) Patent Application Publication
(10) Pub. No.: US 2007/0286087 A1
(43) Pub. Date: Dec. 13, 2007

(54) Distributed Network Enhanced Wellness Checking

(75) Inventors: Matthew C. Compton, Tucson, AZ (US); Andrew G. Hourselt, Tucson, AZ (US); Stefan Lehmann, Tucson, AZ (US); Steve P. Wallace, Casa Grande, AZ (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/423,721

(22) Filed: Jun. 13, 2006

(51) Int. Cl. G06F 11/00; H04J 3/14

(52) U.S. Cl. 370/242; 714/4

(57) ABSTRACT

A method for performing wellness checking on a plurality of distributed networks of independent subsystems, the plurality of distributed networks including a plurality of first nodes and a plurality of second nodes, the method comprising: allowing initialization of a wellness check on the plurality second nodes; allowing each of the plurality of first nodes to send a request to corresponding plurality of second nodes; commencing a first wellness check for checking a first wellness status of each of the plurality of second nodes; checking for the physical network connection of each of the plurality of second nodes; sending wellness status with a determined severity level of each of the plurality of second nodes to corresponding plurality of first nodes; establishing errors of each of the plurality of second nodes; commencing a second wellness check for re-checking a second wellness status of each of the plurality of second nodes with the established errors; sending a notification identifying the established errors; and scheduling a third wellness check for re-checking a third wellness status of each of the plurality of second nodes after a predetermined period of time.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to distributed network enhanced wellness checking, and particularly to performing wellness checking to multiple networks for allowing the incorporation of multiple dependencies of each node of the multiple networks.

2. Description of Background

Complex distributed networks contain numerous dependencies between their systems. A failure of any of these dependencies could result in a failure of the entire system, thus causing a loss of functionality, data, or even security. Different hardware or conflicting levels of software existing within the nodes of the network make exhaustive fault monitoring and preventative wellness checking difficult. Problems that remain undetected can take extended lengths of time to diagnose, thus resulting in high support costs and loss of customer confidence.

U.S. Pat. No. 6,079,033 illustrates a single piece of hardware's ability within a network to receive a wellness message, modify the message to reflect its own wellness, and transmit the modified message to another system. Within this distributed network, the wellness of a single node could depend not only on one of its attached nodes but on a combination of all of its attached nodes and their connectivity to each other. However, a method is needed to account for numerous status messages at once and react accordingly.

U.S. Pat. No. 5,487,148 describes a system that has the ability to receive fault notifications from within a network, compare their severity, and either display an alarm or not. However, this implementation relies on a central computer system to do all of the fault gathering and analysis in order to determine the severity of the detected fault.

Furthermore, in traditional distributed network systems, when a node is receiving a message, altering it for its own wellness, and forwarding it on, a hardware modification, such as replacing a cable could result in severe problem notification. For instance, the temporary loss of connectivity between two systems on the wellness path could result in a message of system loss or even the loss of the entire message.

Furthermore, in traditional distributed network systems, a central computer system initiates and analyzes the wellness check results, thus resulting in a loss of reliability of the wellness check for certain areas of the network. By determining severity from only the messages of the nodes directly attached to the centralized system, problems within the network could easily be viewed as a severe problem by the centralized system.

It is well known that undetected faults can take extended time for diagnosis within a distributed network, thus resulting in high costs and loss of customer confidence. Therefore, it is desired to provide a method for performing wellness checking in an entire network, as well as peer networks, allowing for the incorporation of multiple dependencies of each node, isolating temporary network failure, and eliminating the need for a central computer system.

### SUMMARY OF THE INVENTION

The shortcomings of the prior art are overcome and additional advantages are provided through the provision of a method for performing wellness checking on a plurality of distributed networks of independent subsystems, the plurality of distributed networks including a plurality of first nodes and a plurality of second nodes, the method comprising: allowing initialization of a wellness check on the plurality second nodes; allowing each of the plurality of first nodes to send a request to corresponding plurality of second nodes; commencing a first wellness check for checking a first wellness status of each of the plurality of second nodes; checking for the physical network connection of each of the plurality of second nodes; sending wellness status with a determined severity level of each of the plurality of second nodes to corresponding plurality of first nodes; establishing errors of each of the plurality of second nodes; commencing a second wellness check for re-checking a second wellness status of each of the plurality of second nodes with the established errors; sending a notification identifying the established errors; and scheduling a third wellness check for re-checking a third wellness status of each of the plurality of second nodes after a predetermined period of time.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which performs wellness checking on distributed networks of independent subsystems.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a distributed wellness system.

The detailed description explains the preferred embodiments of the invention, together with advantages and features, by way of example with reference to the drawings.

### DETAILED DESCRIPTION OF THE INVENTION

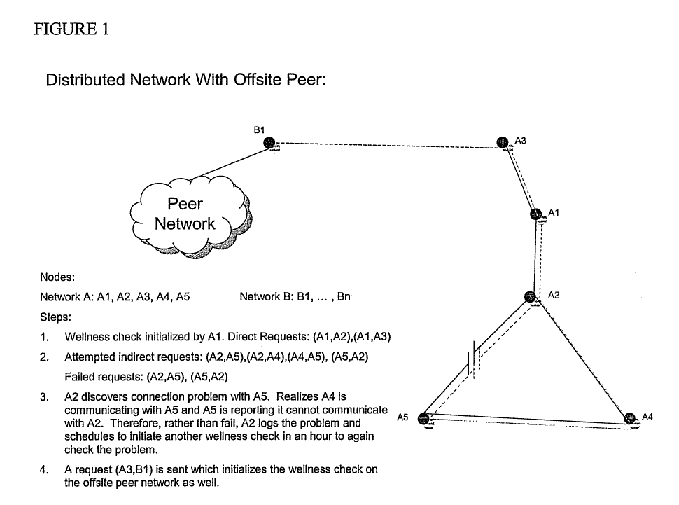

Turning now to the drawings in greater detail, FIG. 1 illustrates the distributed wellness system of the present application. FIG. 1 illustrates a network having a number of nodes. A system wide wellness check may be initiated from any node throughout a distributed network. Every node throughout the network, regardless of hardware or software levels, contains a common wellness-checking interface. As a node receives a request for a wellness check, it queries the corresponding nodes attached to it. The checking node can then interpret each response together, decide on a level of severity with respect to its specific needs, and send off the resulting response to the appropriate path. The original initiating node can then decide on the overall wellness or ‘health’ of the network by monitoring the responses from only those nodes directly attached to it.

Referring to FIG. 1, a network consists of any given number of nodes (A_1, A_2, . . . , A_n).

Any number of offsite peer networks could exists as well (B_1, B_2, B_m).

Each node has a number of connections to other nodes (A_1,A_2), (A_1,A_3), . . . , (A_x, A_y).

For example, the distributed network system of FIG. 1 illustrates the process followed between a plurality of distributed networks in performing wellness checking between a plurality of first nodes and a plurality of second nodes. In particular is performed as follows.

A node A_i initializes a wellness check. This distributed network system sends a wellness request to its connected nodes: Direct requests=(A_i, A_j) . . . (A_i, A_y).

Only requests sent from the initiating node to direct peers are considered direct. All other requests are considered indirect requests. The initiating nodes are considered the plurality of first nodes.

Next, each node (plurality of first nodes) then sends a request to its corresponding attached nodes. These are indirect requests. The attached nodes are considered the plurality of second nodes.

When a given node receives a request, it can take any one of the following actions.

a. Start a machine specific wellness check. This step enables the checking of the status of each node and allows the sending of requests to all attached distributed network systems.

b. If a machine specific wellness check has already been initialized at this node, a response of “In Progress” is returned to the sending node. This step enables the checking of the physical network connection while also avoiding endless recursive loops within the distributed network.

When a given node has tested and gotten responses from all of its available attached systems via its machine specific wellness check from an indirect request, it can decide on any combination of the following options.

a. Send a summary of its wellness status compiled from itself as well as its attached systems with a determined severity level to the requesting node.

b. Log any known issues it has discovered.

c. Schedule a wellness initialization of its own if issues are present it feels needs to be analyzed again in a certain amount of time.

When the initializing node A_i receives all of its responses to the direct requests, it can decide on any combination of the following options:

a. Send a problem notification to the next level of support for any severe problems that have been discovered.

b. Log any less severe problems that have been discovered.

c. Schedule a follow up wellness initialization in a specified period of time to follow up on any issues that have been discovered.

FIG. 1 illustrates an exemplary network, where there is an interruption between nodes A2 and A5. The process for performing network wellness check is as follows. A wellness check initialized by node A1 sends direct requests to directly connected nodes as (A1,A2),(A1,A3). Additionally, indirect requests (status requests between nodes other than the initiating node) including the following requests (A2,A5),(A2,A4),(A4,A5), (A5,A2). Status requests (A2,A5), (A5,A2) fail due to the interruption in the network between these two nodes.

Node A2 discovers connection problem with A5. Node A2 realizes that node A4 is communicating with node A5 and node A5 is reporting it cannot communicate with node A2. Therefore, rather than fail, node A2 logs the problem and schedules to initiate another wellness check in an hour to again check the problem. A status request may also initialize a wellness check on the offsite peer network as well, as represented by request (A3,B1).

Furthermore, the process for performing network wellness checking illustrated in FIG. 1 allows for incorporation of multiple dependencies of each node as well as multiple communication paths to each node. Thus, each of the distributed networks possesses a system-wide capability to isolate temporary network failures without the need to shut down any distributed network in order to provide maintenance. As a result, each of the plurality of nodes (e.g., node A2) may simultaneously check each of the attached nodes (e.g., node A5) in order to isolate non-critical network problems, without jeopardizing the continued functionality of the distributed networks. This system allows not only isolation of communication problems, but also for isolation of nodal problems.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for performing wellness checking on a plurality of distributed networks of independent subsystems, the plurality of distributed networks including a plurality of first nodes and a plurality of second nodes, the method comprising:
allowing initialization of a wellness check on the plurality second nodes;
allowing each of the plurality of first nodes to send a request to the plurality of second nodes;
commencing a first wellness check for checking a first wellness status of each of the plurality of second nodes;
checking for the physical network connection of each of the plurality of second nodes;
sending wellness status with a determined severity level of each of the plurality of second nodes to the plurality of first nodes;
establishing errors of each of the plurality of second nodes;
commencing a second wellness check for re-checking a second wellness status of each of the plurality of second nodes with established errors;
sending a notification identifying the established errors; and
scheduling a third wellness check for re-checking a third wellness status of each of the plurality of second nodes after a predetermined period of time.

2. The method of claim 1, wherein the plurality of first nodes send direct requests to the corresponding plurality of second nodes.

3. The method of claim 1, wherein the first wellness check is performed on every one of the plurality of first nodes and on every one of the plurality of second nodes only once in order to avoid endless recursive loops with the plurality of distributed networks.

4. The method of claim 1, wherein the first wellness check allows for an incorporation of multiple dependencies and paths to each of the plurality of first nodes and on each of the plurality of second nodes.

5. The method of claim 1, wherein the first wellness check is configured to isolate network errors of the plurality of distributed networks by providing multiple communication paths to each of the plurality of first nodes and each of the plurality of second nodes.

6. The method of claim 1, wherein the first wellness check allows the plurality of first nodes to initiate wellness checks as well as resolve system errors without requiring a central computing system.

7. The method of claim 1, wherein each of the plurality of first nodes and each of the plurality of second nodes includes a wellness checking interface.

8. A method for performing wellness checking on any distributed network of independent subsystems, the method comprising:
initiating a diagnostic request;
running a diagnostic program on each of a plurality of network nodes; and
reporting results of running the diagnostic program on each of the plurality of network nodes.
